(19) United States
(12) Patent Application Publication
(10) Pub. No.: US 2023/0045110 A1
(43) Pub. Date: Feb. 9, 2023

(54) IMPORT OF DEPLOYABLE CONTAINERS AND SOURCE CODE IN CLOUD DEVELOPMENT ENVIRONMENT

(71) Applicants: Vidya Ranganathan, Bangalore (IN); Mruthunjaya Chetty, Portland, OR (US); Avinash Reddy Palleti, Bangalore (IN); Ramakrishna Dorairaju, Santa Clara, CA (US)

(72) Inventors: Vidya Ranganathan, Bangalore (IN); Mruthunjaya Chetty, Portland, OR (US); Avinash Reddy Palleti, Bangalore (IN); Ramakrishna Dorairaju, Santa Clara, CA (US)

(21) Appl. No.: 17/972,393

(22) Filed: Oct. 24, 2022

(51) Int. Cl. G06F 21/57; G06F 8/41; G06F 8/61

(52) U.S. Cl. CPC G06F 21/577; G06F 8/41; G06F 8/63

(57) ABSTRACT

Various systems and methods are described for testing and deployment of containers on cloud and edge computing hardware. An example development platform may include capabilities for identifying, from a remote location, data to import a container software package. The development platform may store a container image, based on the data to import the container software package.

The development platform may perform a security evaluation of the container image, before execution of the container image. The development platform may store results of the security evaluation of the container image in a database accessible to the development platform. The development platform may add the container image into a registry of containers available for execution at the development platform, with execution of the container image being based on verification of the results of the security evaluation and use of the registry of containers.

### TECHNICAL FIELD

Embodiments described herein generally relate to data processing in networked computing environments, and in particular, to the use of computing technologies for testing, building, and deployment of containers and other software components on cloud and edge computing hardware.

### BACKGROUND

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an architecture for a cloud development environment, according to an example;

FIG. 2 illustrates a flowchart of a method for import and deployment of pre-built containers, according to an example;

FIG. 3 illustrates a process flow for asynchronous scanning and deployment in a cloud development environment, according to an example;

FIG. 4 illustrates a workflow for importing containers from remote sources into a cloud development environment, according to an example;

FIG. 5 illustrates a flowchart of a method for import and deployment of unbuilt containers, according to an example;

FIG. 6 illustrates a flowchart of a method for processing of container software package images, encompassing the techniques provided among FIGS. 1 to 5, according to an example;

FIG. 7 illustrates an overview of an edge cloud configuration for edge computing, according to an example;

FIG. 8 illustrates deployment and orchestration for virtual edge configurations across an edge-computing system operated among multiple edge nodes and multiple tenants, according to an example;

FIG. 9 illustrates a vehicle compute and communication use case involving mobile access to applications in an edge-computing system, according to an example;

FIG. 10 illustrates a block diagram depicting deployment and communications among several Internet of Things (IoT) devices, according to an example;

FIG. 11 illustrates an overview of layers of distributed compute deployed among an edge computing system, according to an example;

FIG. 12 illustrates an overview of example components deployed at a compute node system, according to an example;

FIG. 13 illustrates a further overview of example components within a computing device, according to an example; and

FIG. 14 illustrates a software distribution platform to distribute software instructions and derivatives, according to an example.

### DETAILED DESCRIPTION

In the following description, methods, configurations, and related apparatuses are disclosed for import and deployment of pre-built containers on the edge for variants of hardware in a development architecture, and for the import of one or more stacks of sources using frameworks and build features on the edge for variants of hardware in a development architecture. Such variants of hardware may be provided by (but are not limited to) a deployment architecture such as the Intel® DevCloud platform, which allows an end-user to actively prototype and experiment with workloads (e.g., AI workflows for computer vision, networking applications for 5G, etc.) on different types of edge/cloud hardware. DevCloud is an example of a Container First Architecture (CFA), also known as Container Playground (CP), which is an architecture operating in a private cloud that allows end-users to bring in one or multiple containers in iterative fashion to develop and test the execution of workloads on Edge nodes.

In a first example, mechanisms and frameworks are described to enable an end-user to perform the import and deployment of pre-built containers for workload execution on the edge, into a cloud development environment such as a CFA deployment architecture. There is a significant need for end-users who are building and testing software, to use individual ingredients required for getting the expected result bundled up together to be able to run the software anywhere, anytime. Container virtualization provides an end-to-end solution for this issue. The CFA model discussed herein enables developers to experiment with, develop, deploy, and manage applications in the form of containers with portability. This mechanism and framework help remove the pain points with bare metal-based infrastructure and design to deliver solutions to best leverage the capabilities of deep learning (and, non-Deep Learning) solutions on underlying hardware.

In a second example, mechanisms and frameworks are described to enable an end-user to import a stack of one or more sources and frameworks, to build a container on the edge, and test such a container across variants of hardware in a cloud development environment such as a CFA deployment architecture. This provides developers with a useful and simplified method to bring (e.g., import) source code of their choice, build the source code along with layers of applications, framework(s) and tools in the software stack, and enable the resulting software for execution on the edge with various processors and accelerators. As a result, containers can be dynamically built within the CFA model to enable developers to experiment with, develop, and deploy software in a cloud development environment.

### Import and Deployment of Pre-Built Containers On The Edge For Variants Of Hardware

The CFA deployment model discussed herein enables end-users to bring in one or multiple pre-built containers for Deep Learning inference into a private development cloud (e.g., hosted by an OEM) to run the workload on the edge nodes. One of the important challenges handled by a CFA deployment includes addressing the security and safety measures during the import of pre-built containers, because a vulnerable container can harm the host machine. To handle security concerns with pre-built containers, the following CFA deployment performs security integrity validation of the container images by scanning the container images in addition to performing privilege management for the given persona or entitlement. A check within an allow list/pass list of image registries is also made prior to import of the container images.

There are no vendors, as of today, who allow import, execution, and testing of pre-built containers with AI or Deep Learning models directly into a cloud environment. This hinders heterogeneity for migration of containerized workloads across the cloud. As a result of such limitations, end-users will have to build (compile) containers every time they wish to deploy containers on new edge nodes. Many cloud providers do not allow import of pre-built containers because of security concerns, which is addressed by the following CFA deployment. Thus, although many existing development architectures do not allow end-users (e.g., customers) to import containerized workloads and deploy them on the edge nodes directly, these technical challenges have been overcome in the following approaches.

The following approaches provide developers with methods to import or create and bring in one or multiple pre-built container applications for execution into a CFA deployment. Such container applications may be imported from an allow list/pass list of image registries, to obtain the benefit of experiencing the performance of Edge hardware configurations without requiring procuring such hardware configurations immediately. Further, the following “Bring Your Own Container” (BYOC) features provide the developer community with an easy, portable, heterogenous solution to validate their Deep Learning models and increase ease of development.

The following approaches are usable in combination with a OpenVINO toolkit (bridge) by enabling inference on the edge with one or multiple pre-built containers. As noted, there are no cloud vendors or competitors today who enable end-users to bring in their pre-built containers for execution on the edge nodes across multiple hardware accelerators. Among others, the following CFA and BYOC deployments are applicable to many types of Deep Learning platforms and frameworks, including TensorFlow, PyTorch, ONNX, Caffe2, CAL D, and MXNet supported by OpenVINO.

The following describes a flow of execution that enables import or creation to bring in one or multiple pre-built containers for deployment of any workload execution. This includes a workflow or execution model of workload across Edge nodes that is made with the import or creation of pre-built containers. Additionally, the following features are enabled by the present CFA deployment configuration.

In an example, a CFA deployment includes unique functions, including enabling an end-user to import one or multiple pre-built containers from an allow list/pass list of image registries to be able to run (execute) on edge nodes across hardware accelerators of choice.

In an example, the allow list/pass-list registries include but are not limited to sources such as docker.io, quay, google, azure, and amazon.

In an example, the image pulled from registries can be public or private with defined user credential management.

In an example, the container(s) imported by the end-user can be logically grouped as co-working containerized applications, which can be either inter-dependent or independent to each other, or can be represented in form of a directed graph or tree representing dependency.

In an example, the containers that are imported can be pushed into a local cluster registry or a centralized global registry.

In an example, the CFA deployment allows movement of containers or container sub-tree across applications which are independent.

In an example, the CFA deployment allows configuration of such imported containers when required.

In an example, the CFA deployment includes a mechanism by which the containers that are imported can be subjected to a security vulnerability scan in asynchronous mode during import. A container scan at time of import can be leveraged by queuing up the imported containers into the scan queue, and only following verification approval, enabling them for deployment.

In an example, the CFA deployment includes a method by which management of the imported containers are covered for retrieval, updates, and deletion (soft or hard).

In an example, the CFA deployment includes containers imported in iterative fashion that are defined, or alternatively, the order is placed for execution across variants of edge hardware.

In an example, the CFA deployment generates results that are made available on the physical volume of the user via a filesystem or a file explorer.

In an example, the CFA deployment enables an executed and running application to include an expose URL for manipulations.

In addition to these aspects, the following describes various types of User interface/User Experience features which enable an import of pre-built containers or containerized applications for deployment across the edge. It will be understood that a variety of documentation, tutorials, demo, and FAQs may expand on these features.

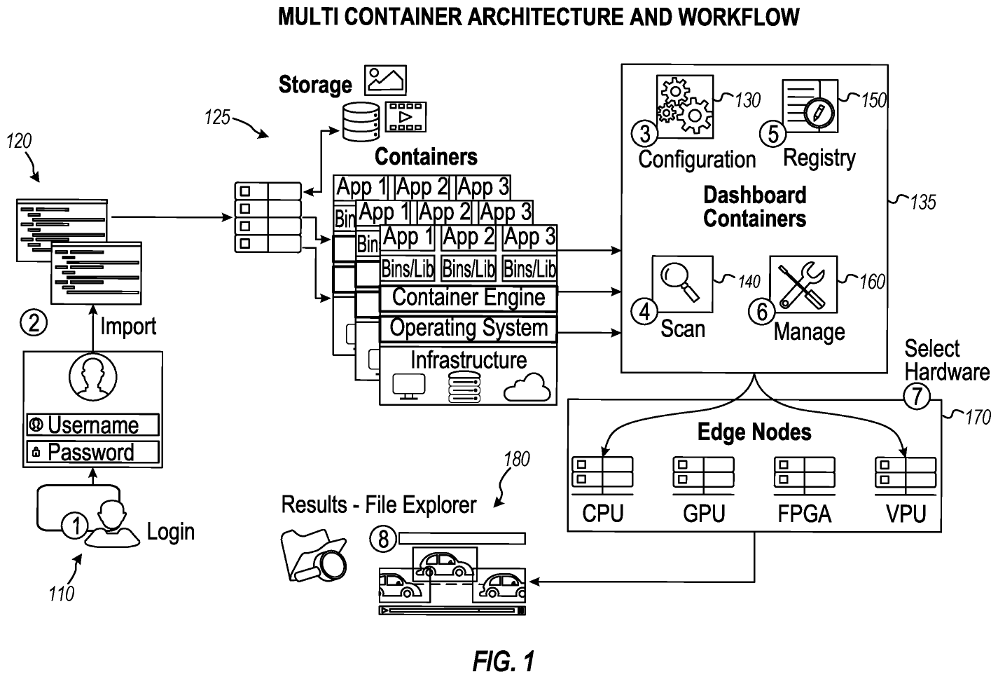

FIG. 1 depicts a workflow of a Container First Architecture according to an example. Here, this figure depicts a “Bring Your Own Container(s)” approach, to enhance developer experience for leveraging Deep Learning solutions on edge nodes by importing pre-built containers. In an example, a workflow for the import and management of containers includes the following:

First, the end-user performs a login (e.g., at 110) into a development system (e.g., Intel DevCloud or another CFA deployment), such as via a secure (e.g., https) protocol. Various authentication methods, such as authentication with Single Sign On [SSO] via SAML/OAuth2 may be employed. Once logged in, the end-user arrives at a landing page or screen.

Next, the end-user is given an option to import a group of one or more containers through “Bring Your Own Container(s)” dialog (e.g., at 120), from a pass list (allowed list) of image registries. The containers thus imported by the end user have a parent container whose sub-containers shall be dependent on the same. These are termed as inter-dependent containers. Also, the containers can be independent with each one of them holding its own entry-point for start of execution.

Multiple containers C1, C2 . . . Cn (e.g., the set of containers depicted at 125) are thus allowed to be imported into a logical entity and grouped together. These containers can be moved across the group as well. Multiple containers are imported in an iterative fashion one after another and dependency tree is defined. The containers thus imported can be placed in the internal registry as well (e.g., at 150). Further, configuration parameters for the imported containers are picked up and saved (e.g., at 130).

Once the URL for a container image is provided, an asynchronous call is made to the Image Scanner which checks for security integrity validation of the container images. The Image Scanning request (e.g., at 140) is first placed in a distributed queue. A consumer will pick the image scanning request from the queue and then send it to image scanning tool. After the results are provided from the image scanning tool, it is then published to the queue by the publisher. Another consumer can fetch the finished job from the queue and save the result of image scanning into a database. Other management operations also can be performed (e.g., at 160).

Before deployment to selected edge nodes (e.g., at 170), the database is checked for image scanning result. Based on the status of security integrity the deployment is carried forward, to provide results or other file output (e.g., results of inference workloads at 180). When executing, validation of the container from the registry (internal or external) can occur seamlessly. For example, validation may be performed as an asynchronous call that will not affect the next import flow in iterative fashion.

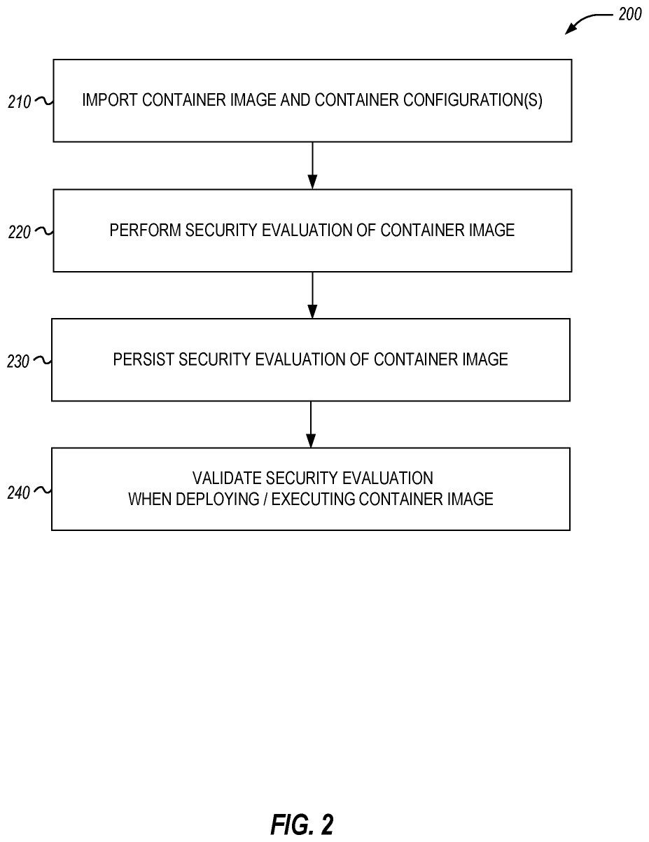

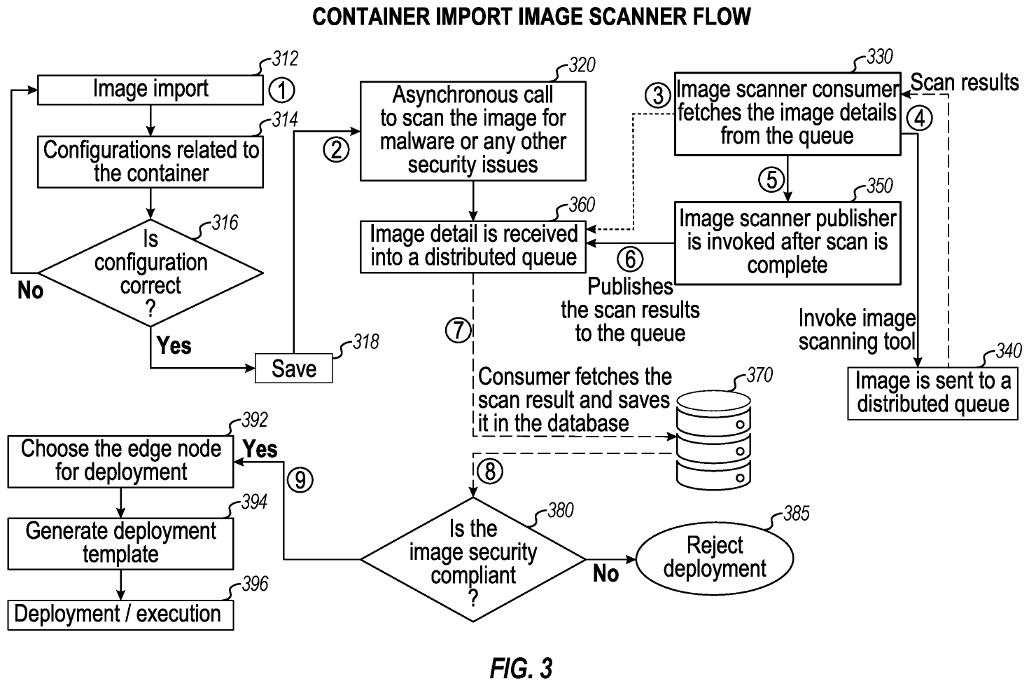

FIG. 2 illustrates a flowchart 200 of an example method for import and deployment of pre-built containers. This method may be supplemented by the detailed operations discussed herein with reference to FIGS. 1 and 3.

At 210, operations are performed in a development architecture to import one or more container image and container configurations. The instructions or information to begin the import may be specified within a user interface, as noted above.

At 220, operations are performed in the development architecture to perform a security evaluation of the imported container image. This may include an evaluation of the image for malware, the use of privileges to execute applications or services in the image, and other security actions.

At 230, the security evaluation results (such as a pass result of the security evaluation) for the container image are saved, stored in the development architecture (e.g., in a database or other storage), for later use.

At 240, at runtime for the container image, the security evaluation results are validated. For instance, this validation may occur when deploying or executing the container image.

FIG. 3 provides a pictorial representation of the import for asynchronous scanning and deployment. This includes the import and scanning steps discussed above.

In detail, the import process begins as a container image is imported (e.g., at 312) and configurations related to the container are imported (e.g., at 314). A configuration verification process (e.g., at 316) to check the security details of the container execution configuration is performed before saving the configuration (e.g., at 318). This is followed by an asynchronous call to scan the container image for malware or any other security issues (e.g., at 320).

The security scanning is depicted as including operations by: (i) an image scanner consumer, which fetches the image details from the queue (e.g., at 330), invokes an image scanning tool on an image sent to a distributed queue (e.g., at 340); and (ii) an image scanner publisher, which is invoked after the scan is complete (e.g., at 350). This image scanner publisher then publishes the scan results to the distributed queue, and security details of the image are received into the distributed queue (e.g., at 360).

A consumer (e.g., an entity who uses the container to perform some workload) fetches the security scan result and saves it into a database (e.g., at 370). This security scan result is then used in an evaluation (e.g., at 380) of whether the container image is security compliant. If the results indicate that the container image is not security compliant, then deployment of the container image is rejected (e.g., at 385). If the results indicate that the container image is security compliant, then deployment is provided, such as with steps to choose an edge node for deployment (e.g., at 392), to generate a deployment template (e.g., at 394), and to finally coordinate the execution and deployment on the edge node (e.g., at 396).

In further examples, functionality is provided to allow saving of the imported containers into private registries for deployments. Also, management of imported containers may be enabled for operations such as updates, removals, and listings.

As noted above, the imported containers can be deployed across variants of hardware accelerators and processors. Ultimately, results can be generated and viewed via a file-explorer on a dashboard. Other use cases for usage and deployment may also be enabled.

### Importing Stack(s) of Sources with Frameworks and Builds of the Sources on the Edge Across Variants of Hardware

The following describes additional functionality to enable developers to bring source code of their choice and build such source code into containers, while importing and building the appropriate layers of applications, framework(s) and tools in the software stack. The results of such a build can enable execution of the software on an edge-based development architecture with various processors and accelerators.

Existing deployment architectures do not allow end users to import and build sources for execution of Deep Learning applications on the Edge.

Likewise, similar approaches in the market have limitations. Current approaches only allow limited generation of container images by seeking model data or training data from the end-user; however, they do not provide a straightforward mechanism for the end-user to import source code Git repository for various programming language and build them for executions on the edge. Further, the existing state of the art does not allow layering a stack of applications, frameworks, or tools to be built along with source code for executions across the edge.

In an example, functionality is provided in a CFA deployment to import source code from a repository, such as a GIT repository. Here, this may include the import of code in various programming languages along with desired groups of tools, applications, and frameworks for an integrated build and execution on the edge across various types of hardware. This functionality can significantly enhance developer experience on edge computing, when using a development environment for testing Deep Learning solutions with simplicity, scalability, portability, performance, and ease of use.

The following approaches are usable in combination with an OpenVINO toolkit (bridge). As noted, there are no cloud vendors or competitors today who enable end-users to build a stack of sources across various programming languages and application frameworks for execution across the edge. Among others, the following CFA and BYOC deployments are applicable to many types of Deep Learning platforms and frameworks, including TensorFlow, PyTorch, ONNX, Caffe2, CAL D, and MXNet supported by OpenVINO.

Similar to the features noted above, the following also describes various types of user interface/user experience features which enable an import of source code from a repository. It will be understood that a variety of documentation, tutorials, demo, and related tools may expand on these features.

In particular, the following can be expanded by a flow of execution that dictates import of source code from the GIT repository across various programming languages with an integrated build on stack of applications, tools, frameworks. Additionally, the following features are enabled by the present CFA deployment configuration:

In an example, a CFA deployment is configured to import source code from private or public git repositories.

In an example, the CFA deployment is configured to import a Dockerfile (a text document that contains commands used to assemble a Docker container image) or similar container build instructions.

In an example, the CFA deployment is configured to enable compilation of source code across programming languages (e.g., Java, Python, C++, GoLang, Node.JS).

In an example, the CFA deployment is configured to include a facility to debug, rebuild and optimize the solution, models, or framework in the workload.

In an example, the CFA deployment is configured to provide tools or applications to be integrated along with compilation for build.

In an example, the CFA deployment is configured to build layers on the top of a virtual image (TensorFlow, PyTorch, OpenVINO, ONNX). The CFA deployment may also provide a selection of layers across variants and versions.

In an example, the CFA deployment is configured to store the virtual images into a general-purpose registry, or to store virtual images in a local or remote repository after generation of the same.

In an example, the CFA deployment is configured to compile source code with integrated layers via command line interface, or via a graphical interface.

Finally, in an example, the CFA deployment is configured to provide a security compliant execution of the container images generated from builds across variants of hardware. This may include security validation steps noted above with reference to FIGS. 1 to 3.

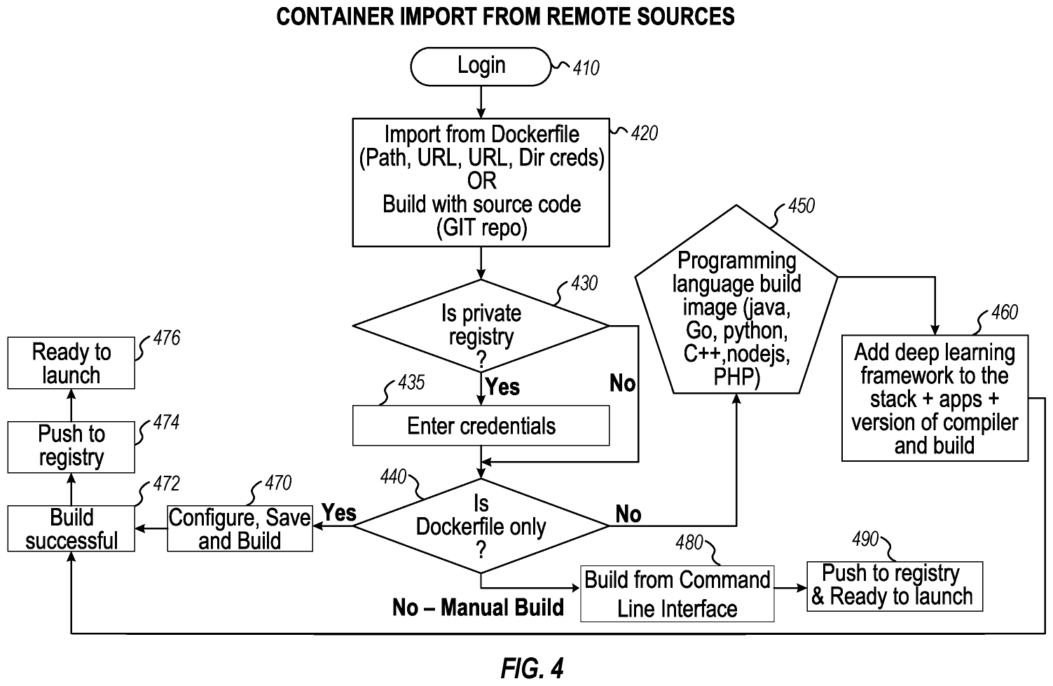

FIG. 4 depicts a workflow for importing containers from remote sources into a cloud development environment, according to an example. In an example, a workflow for importing container source code or container build instructions (e.g., a Dockerfile) includes the following:

First, the end-user performs a login (e.g., at 410) into an implementing site (e.g., Intel DevCloud or another CFA deployment), such as by using a portal accessed via an authentication method (e.g., via single sign on).

Next, after login, the end-user is provided with two or more options to import source code or specifications (e.g., at 420), including from a Dockerfile or source code in a GIT repository. If the registry is private (e.g., as evaluated at 430), credentials are obtained from the user (e.g., at 435).

Next, if the GIT repository contains a Dockerfile only (e.g., as evaluated at 440), then a direct build is instantiated for the generation of the container from an image (e.g., at 470). If the GIT repository includes container source code (e.g., as evaluated at 440), then information is obtained (e.g., at 450) for the programming language type, version of the compiler for the sources to be built, with along with information on additional applications, tools, or framework(s). The grabbed artifacts are subjected to an integrated multi-layered container compilation with the build framework, which is used to build the source code (e.g., at 460).

Upon successful completion of the builds (e.g., evaluated at 472), the container images are pushed to a registry (e.g., at 474) and placed in a state to be ready to launch (e.g., at 476). This may include placing the containers with logical artifacts for launch on the edge across various hardware processors and accelerators.

The deployment architecture may also include capabilities to enable an import and manual build of code, and the build of such code from a command line interface. For example, if the repository does not contain a Dockerfile only (e.g., as evaluated at 440), then a command line interface can be used to manually build the CLI code (e.g., at 480). After build, the container can be pushed to a registry and placed in a state to be ready to launch (e.g., at 490).

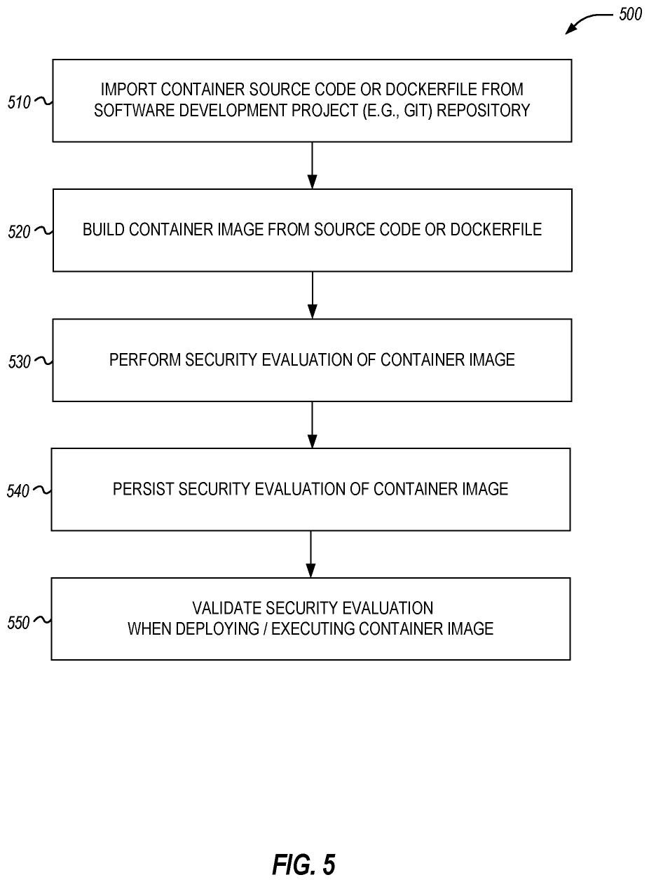

FIG. 5 illustrates a flowchart 500 of an example method for import and deployment of unbuilt containers. This method may be supplemented by the detailed operations discussed herein with reference to FIGS. 2 (and, e.g., providing a variation of the flowchart of FIG. 2 for the import of unbuilt containers).

At 510, operations are performed in a development architecture to import one or more sets of container source code or container build instructions, from a software development project repository (such as a GIT repository). The instructions or information to begin the import may be specified within a user interface, as noted above.

At 520, a container image (or container images) is built from the imported source code or the container build instructions (Dockerfile).

At 530, operations are performed in the development architecture to perform a security evaluation of the imported container image. This may include an evaluation of the image for malware, the use of privileges to execute applications or services in the image, and other security actions.

At 540, the security evaluation results (such as a pass result of the security evaluation) for the container image are persisted in the development architecture (e.g., in a database or other storage), for later use.

At 550, at runtime for the container image, the security evaluation results are validated. For instance, this validation may occur when deploying or executing the container image.

### Example Implementing Methods and Computing Systems

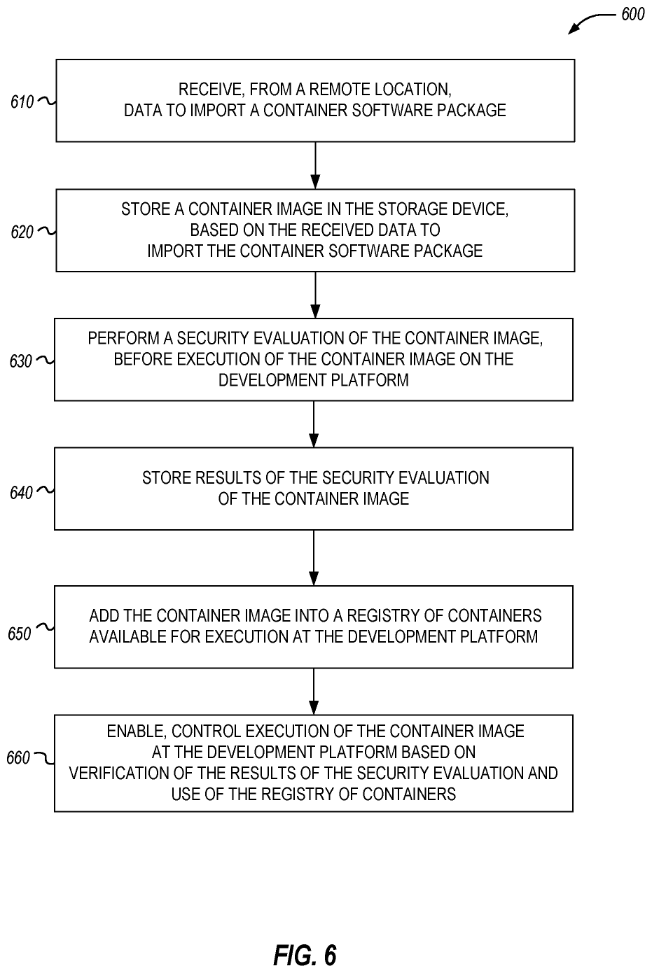

FIG. 6 illustrates a flowchart 600 for processing of container software package images, encompassing the techniques provided among FIGS. 1 to 5. For instance, the following features of flowchart 600 may be integrated or adapted with the pre-built container import operations discussed with reference to FIGS. 1 to 3, or the import operations of code or container build instructions discussed with reference to FIGS. 4 to 5. It will be understood that the processing depicted in flowchart 600 may be implemented by system or device embodiments (e.g., one or more computing systems or hardware contained thereon), machine-readable manufacture embodiments (e.g., a non-transitory computer-readable medium having instructions to be used by the one or more computing systems or hardware), method embodiments (e.g., a method performed by one or more computing systems or hardware), or the like.

At 610, operations are performed to identify and receive (and, as applicable, retrieve), from a remote location, data (e.g., container package data) that enables the import of a container software package into an edge computing development platform. In a first example, detailed with reference to FIGS. 1 to 3, above, the data to import the container software package is a pre-built container image, and the container image is pre-built by a remote computing system prior to import to the development platform. In a second example, detailed with reference to FIGS. 4 to 5 above, the data to import the container software package includes source code.

At 620, operations are performed to store a container image in the storage device, based on the received data to import the container software package. In an example, the container image is one of a plurality of container images that is imported into the development platform. Such a plurality of container images may include containers that are inter-dependent. In the example where source code is imported, further operations (not depicted) may include compiling the container image from the source code or container build instructions before storing the container image (at the development platform). In a specific example, the source code or container build instructions are obtained from a software development project repository (e.g., GIT repository).

At 630, operations are performed to conduct a security evaluation of the container image, before execution of the container image on the development platform. At 640, the results of the security evaluation are stored (e.g., in a database).

At 650, operations are performed to add the container image into a registry of containers available for execution at the development platform. Such a registry may also include the use of configuration information, such as a configuration of the container image that is specifically enabled and provided for testing and deployment on the development platform.

At 660, the flowchart concludes with operations that enable execution, control execution, or cause execution of the container image at the development platform. This execution may be based on verification of the results of the security evaluation and use of the registry of containers. In still further examples, the execution includes performance of one or more workloads distributed among a selected set of hardware of the plurality of types of hardware. As discussed herein, such hardware may be “edge computing hardware” that is lightweight or reduced-power/reduced-resource. Such edge computing hardware includes hardware processors and compute units that are commonly used by edge nodes (e.g., by processing nodes at the edge of a network, rather than high-performance processing nodes in a dedicated data center).

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method for processing of container software package images for use in an edge computing development platform, comprising: identifying container package data stored at a remote location, the container package data to be imported into the development platform; storing a container image at the development platform, based on the container package data; performing a security evaluation of the container image, before execution of the container image on the development platform; storing results of the security evaluation of the container image in a database accessible to the development platform; and adding the container image into a registry of containers available for execution at the development platform; wherein execution of the container image at the development platform is based on verification of the results of the security evaluation and use of the registry of containers.

In Example 2, the subject matter of Example 1 optionally includes subject matter where the container package data is a pre-built container image, wherein the container image is pre-built by a remote computing system prior to import to the development platform.

In Example 3, the subject matter of any one or more of Examples 1-2 optionally include subject matter where the container package data includes source code, and wherein the method further comprises: compiling the container image from the source code or container build instructions, at the development platform, before storing the container image.

In Example 4, the subject matter of Example 3 optionally includes subject matter where the source code or container build instructions are obtained from a software development project repository.

In Example 5, the subject matter of any one or more of Examples 1-4 optionally include subject matter where the container image is one of a plurality of container images to import into the development platform.

In Example 6, the subject matter of Example 5 optionally includes subject matter where the plurality of container images provides one or more containers that are inter-dependent.

In Example 7, the subject matter of any one or more of Examples 1-6 optionally include implementing a configuration of the container image on the development platform.

In Example 8, the subject matter of any one or more of Examples 1-7 optionally include subject matter where the development platform comprises a plurality of types of hardware available for execution of the container image.

In Example 9, the subject matter of Example 8 optionally includes causing the execution of the container image at the development platform, wherein the execution includes performance of one or more workloads distributed among a selected set of hardware of the plurality of types of hardware.

Example 10 is at least one non-transitory machine-readable medium capable of storing instructions for processing of container software package images, wherein the instructions when executed by a computing device of an edge computing development platform, cause the computing device to perform operations that: obtain, from a remote location, data to import a container software package into the development platform; store a container image at the development platform, based on the data to import the container software package; performing a security evaluation of the container image, before execution of the container image on the development platform; storing results of the security evaluation of the container image in a database accessible to the development platform; and adding the container image into a registry of containers available for execution at the development platform; wherein execution of the container image at the development platform is based on verification of the results of the security evaluation and use of the registry of containers.

In Example 11, the subject matter of Example 10 optionally includes subject matter where the data to import the container software package is a pre-built container image, wherein the container image is pre-built by a remote computing system prior to import to the development platform.

In Example 12, the subject matter of any one or more of Examples 10-11 optionally include subject matter where the data to import the container software package includes source code, and wherein the instructions further cause the computing device to perform operations that: compile the container image from the source code or container build instructions, at the development platform, before storing the container image.

In Example 13, the subject matter of Example 12 optionally includes subject matter where the source code or container build instructions are obtained from a software development project repository.

In Example 14, the subject matter of any one or more of Examples 10-13 optionally include subject matter where the container image is one of a plurality of container images to import into the development platform.

In Example 15, the subject matter of Example 14 optionally includes subject matter where the plurality of container images provides one or more containers that are inter-dependent.

In Example 16, the subject matter of any one or more of Examples 10-15 optionally include subject matter where the instructions further cause the computing device to perform operations that: implement a configuration of the container image on the development platform.

In Example 17, the subject matter of any one or more of Examples 10-16 optionally include subject matter where the development platform comprises a plurality of types of hardware available for execution of the container image.

In Example 18, the subject matter of Example 17 optionally includes subject matter where the instructions further cause the computing device to perform operations that: cause the execution of the container image at the development platform, wherein the execution includes performance of one or more workloads distributed among a selected set of hardware of the plurality of types of hardware.

Example 19 is a system for managing container software package images in an edge computing development platform, the system comprising: a storage device to store data for a plurality of container images of the development platform; and processing circuitry to: receive, from a remote location, data to import a container software package; store a container image in the storage device, based on the data to import the container software package; perform a security evaluation of the container image, before execution of the container image on the development platform; store results of the security evaluation of the container image in the storage device; and add the container image into a registry of containers available for execution at the development platform; wherein execution of the container image at the development platform is based on verification of the results of the security evaluation and use of the registry of containers.

In Example 20, the subject matter of Example 19 optionally includes subject matter where the data to import the container software package is a pre-built container image, wherein the container image is pre-built by a remote computing system prior to import to the development platform.

In Example 21, the subject matter of any one or more of Examples 19-20 optionally include subject matter where the data to import the container software package includes source code or container build instructions, wherein the source code or container build instructions are obtained from a software development project repository and wherein the processing circuitry is further to: compile the container image from the source code or container build instructions, at the development platform, before storing the container image.

In Example 22, the subject matter of any one or more of Examples 19-21 optionally include subject matter where the processing circuitry is further to: control the execution of the container image at the development platform, wherein the execution includes performance of one or more workloads distributed among a plurality of types of hardware at the development platform.

Example 23 is an apparatus for processing of container software package images, for use in an edge computing development platform, the apparatus comprising: means for obtaining data to import a container software package into the development platform; means for storing a container image at the development platform, based on the data to import the container software package; means for performing a security evaluation of the container image, before execution of the container image on the development platform; means for storing results of the security evaluation of the container image in a database accessible to the development platform; means for adding the container image into a registry of containers available for execution at the development platform; and means for executing the container image at the development platform based on verification of the results of the security evaluation and use of the registry of containers.

In Example 24, the subject matter of Example 23 optionally includes subject matter where the data to import the container software package is a pre-built container image, wherein the container image is pre-built by a remote computing system prior to import to the development platform.

In Example 25, the subject matter of any one or more of Examples 23-24 optionally include subject matter where the data to import the container software package includes source code or container build instructions, wherein the source code or container build instructions are obtained from a software development project repository, and wherein the apparatus further comprises: means for compiling the container image from the source code or container build instructions before storing the container image.

In Example 26, the subject matter of any of the preceding examples may be extended by executing the workload “N” times on the edge computing hardware, and optionally, obtaining and identifying comparisons among the execution of the workloads.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

### Example Edge Computing Architectures

Although the previous discussion was provided with reference to specific networked compute deployments, it will be understood that the build, testing, or deployment instances may be implemented at any number of devices that access services from the “cloud”, devices that access services from the “edge cloud”, or devices that access services from the “data center cloud”.

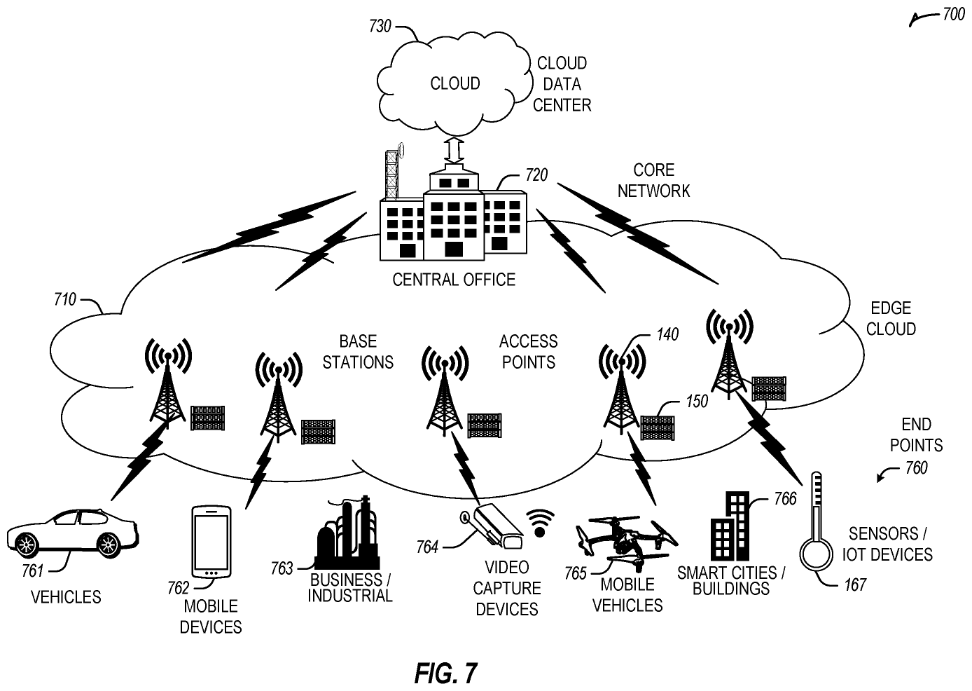

FIG. 7 is a block diagram 700 showing an overview of a configuration for edge computing, which includes a layer of processing referenced in many of the current examples as an “edge cloud”. As shown, the edge cloud 710 is co-located at an edge location, such as an access point or base station 740, a local processing hub 750, or a central office 720, and thus may include multiple entities, devices, and equipment instances. The edge cloud 710 is located much closer to the endpoint (consumer and producer) data sources 760 (e.g., autonomous vehicles 761, user equipment 762, business and industrial equipment 763, video capture devices 764, mobile vehicles (e.g., drones) 765, smart cities and building devices 766, sensors and IoT devices 767, etc.) than the cloud data center 730. Compute, memory, and storage resources which are offered at the edges in the edge cloud 710 are critical to providing ultra-low latency response times for services and functions used by the endpoint data sources 760 as well as reduce network backhaul traffic from the edge cloud 710 toward cloud data center 730 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures.

These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 7, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data-center.

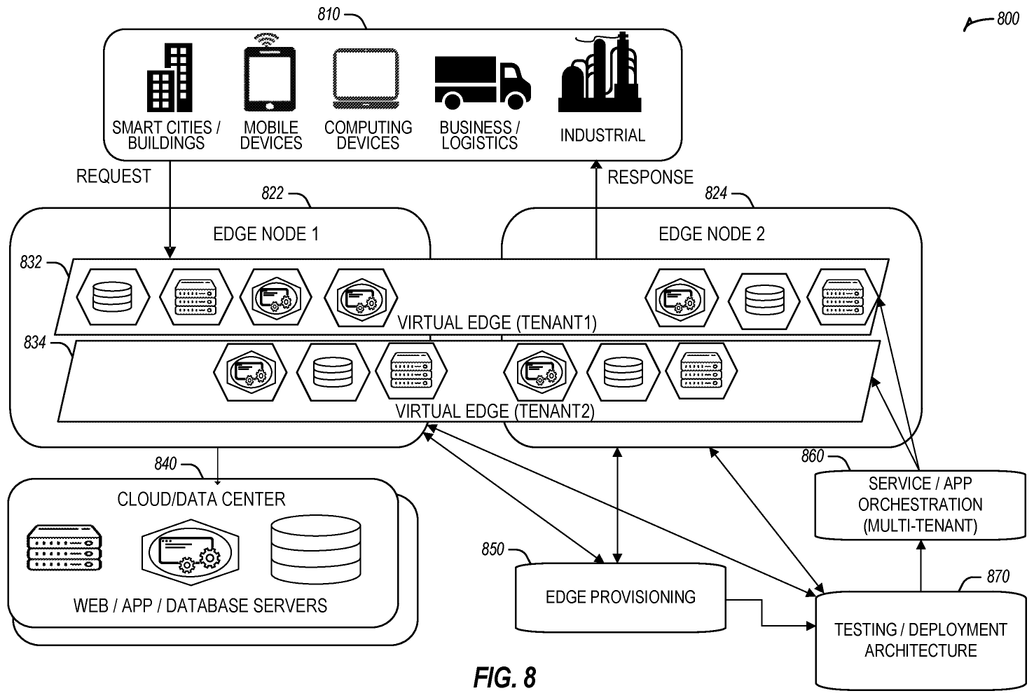

FIG. 8 illustrates deployment and orchestration for virtual edge configurations across an edge computing system operated among multiple edge nodes and multiple tenants. Specifically, FIG. 8 depicts coordination of a first edge node 822 and a second edge node 824 in an edge computing system 800, to fulfill requests and responses for various client endpoints 810 (e.g., smart cities/building systems, mobile devices, computing devices, business/logistics systems, industrial systems, etc.), which access various virtual edge instances. The virtual edge instances 832, 834 (or virtual edges) provide edge compute capabilities and processing in an edge cloud, with access to a cloud/data center 840 for higher-latency requests for websites, applications, database servers, etc. Thus, the edge cloud enables coordination of processing among multiple edge nodes for multiple tenants or entities.

In the example of FIG. 8, these virtual edge instances include a first virtual edge 832, offered to a first tenant (Tenant 1), which offers a first combination of edge storage, computing, and services; and a second virtual edge 834, offering a second combination of edge storage, computing, and services, to a second tenant (Tenant 2). The virtual edge instances 832, 834 are distributed among the edge nodes 822, 824, and may include scenarios in which a request and response are fulfilled from the same or different edge nodes. The configuration of each edge node 822, 824 to operate in a distributed yet coordinated fashion occurs based on edge provisioning functions 850. The functionality of the edge nodes 822, 824 to provide coordinated operation for applications and services, among multiple tenants, occurs based on orchestration functions 860. Such functionality may be extended for use with the testing and deployment architecture 870 (e.g., for import and execution of containers) as discussed in the various examples above.

It should be understood that some of the devices in 810 are multi-tenant devices where Tenantl may function within a Tenant1 ‘slice’ while a Tenant2 may function within a Tenant2 ‘slice’ (and, in further examples, additional or sub-tenants may exist; and each tenant may even be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A RoT may further be computed dynamically composed using a compute security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 810, 822, and 840 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other compute security functions related to the provisioning and lifecycle of the trusted ‘slice’ concept in FIG. 8. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or, respective computing systems and resources which are co-owned or co-managed by multiple owners).

For instance, each edge node 822, 824 may implement the use of containers, such as with the use of a container “pod” 826, 828 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 832, 834 are partitioned according to the needs of each container.

With the use of container pods, a pod controller oversees the partitioning and allocation of containers and resources. The pod controller receives instructions from an orchestrator (e.g., performing orchestration functions 860) that instructs the controller on how to appropriately partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a compute security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator 860 may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to each tenant (aside from the execution of virtualized network functions).

Within the edge cloud, a first edge node 822 (e.g., operated by a first owner) and a second edge node 824 (e.g., operated by a second owner) may operate or respond to a container orchestrator to coordinate the execution of various applications within the virtual edge instances offered for respective tenants. For instance, the edge nodes 822, 824 may be coordinated based on edge provisioning functions 850, while the operation of the various applications is coordinated with orchestration functions 860.

Various system arrangements may provide an architecture that treats VMs, Containers, and Functions equally in terms of application composition (and resulting applications are combinations of these three ingredients). Each ingredient may involve the use of one or more accelerator (e.g., FPGA, ASIC) components as a local backend. In this manner, applications can be split across multiple edge owners, coordinated by an orchestrator.

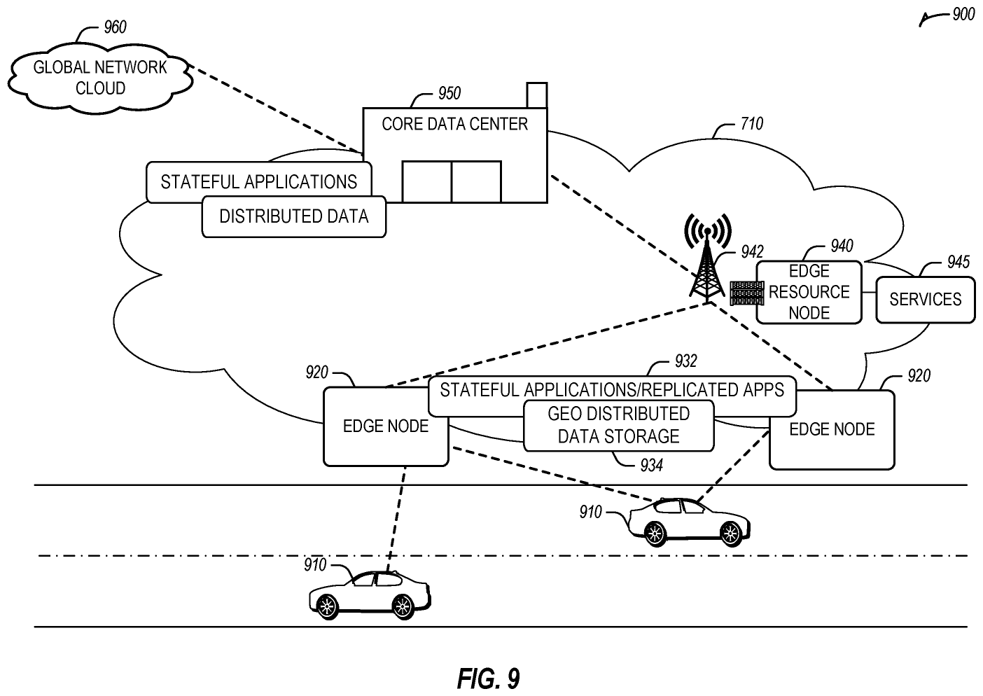

It should be appreciated that the edge computing systems and arrangements discussed herein may be applicable in various solutions, services, and/or use cases. As an example, FIG. 9 shows a simplified vehicle compute and communication use case involving mobile access to applications in an edge computing system 900 that implements an edge cloud 710 connected to service instances 945. In this use case, each client compute node 910 may be embodied as in-vehicle compute systems (e.g., in-vehicle navigation and/or infotainment systems) located in corresponding vehicles that communicate with the edge gateway nodes 920 during traversal of a roadway. For instance, edge gateway nodes 920 may be located in roadside cabinets, which may be placed along the roadway, at intersections of the roadway, or other locations near the roadway. As each vehicle traverses along the roadway, the connection between its client compute node 910 and a particular edge gateway node 920 may propagate to maintain a consistent connection and context for the client compute node 910. Each of the edge gateway nodes 920 includes some processing and storage capabilities and, as such, some processing and/or storage of data for the client compute nodes 910 may be performed on one or more of the edge gateway nodes 920.

Each of the edge gateway nodes 920 may communicate with one or more edge resource nodes 940, which are illustratively embodied as compute servers, appliances or components located at or in a communication base station 942 (e.g., a base station of a cellular network). As discussed above, each edge resource node 940 includes some processing and storage capabilities, and, as such, some processing and/or storage of data for the client compute nodes 910 may be performed on the edge resource node 940. For example, the processing of data that is less urgent or important may be performed by the edge resource node 940, while the processing of data that is of a higher urgency or importance may be performed by edge gateway devices or the client nodes themselves (depending on, for example, the capabilities of each component). Further, various wired or wireless communication links (e.g., fiber optic wired backhaul, 5G wireless links) may exist among the edge nodes 920, edge resource node(s) 940, core data center 950, and network cloud 960.

The edge resource node(s) 940 also communicate with the core data center 950, which may include compute servers, appliances, and/or other components located in a central location (e.g., a central office of a cellular communication network). The core data center 950 may provide a gateway to the global network cloud 960 (e.g., the Internet) for the edge cloud 710 operations formed by the edge resource node(s) 940 and the edge gateway nodes 920. Additionally, in some examples, the core data center 950 may include an amount of processing and storage capabilities and, as such, some processing and/or storage of data for the client compute devices may be performed on the core data center 950 (e.g., processing of low urgency or importance, or high complexity). The edge gateway nodes 920 or the edge resource nodes 940 may offer the use of stateful applications 932 and a geographically distributed data storage 934 (e.g., database, data store, etc.).

In further examples, FIG. 9 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 920, some others at the edge resource node 940, and others in the core data center 950 or the global network cloud 960.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

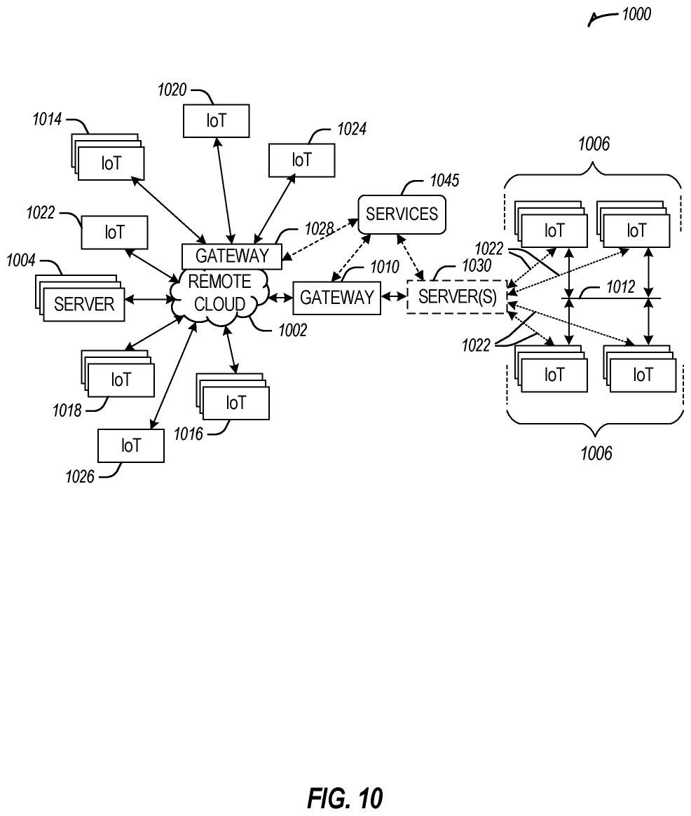

As a more detailed illustration of an Internet of Things (IoT) network, FIG. 10 illustrates a drawing of a cloud or edge computing network 1000, in communication with several IoT devices and a container development and execution services 1045. The IoT is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 10, the network 1000 may represent portions of the Internet or may include portions of a local area network (LAN), or a wide area network (WAN), such as a proprietary network for a company. The IoT devices may include any number of different types of devices, grouped in various combinations. For example, a traffic control group 1006 may include IoT devices along streets in a city. These IoT devices may include stoplights, traffic flow monitors, cameras, weather sensors, and the like. The traffic control group 1006, or other subgroups, may be in communication within the network 1000 through wired or wireless links 1008, such as LPWA links, optical links, and the like. Further, a wired or wireless sub-network 1012 may allow the IoT devices to communicate with each other, such as through a local area network, a wireless local area network, and the like. The IoT devices may use another device, such as a gateway 1010 or 1028 to communicate with remote locations such as remote cloud 1002; the IoT devices may also use one or more servers 1030 to facilitate communication within the network 1000 or with the gateway 1010. For example, the one or more servers 1030 may operate as an intermediate network node to support a local edge cloud or fog implementation among a local area network. Further, the gateway 1028 that is depicted may operate in a cloud-to-gateway-to-many edge devices configuration, such as with the various IoT devices 1014, 1020, 1024 being constrained or dynamic to an assignment and use of resources in the network 1000.

In an example embodiment, the network 1000 can further include or be communicatively coupled to a service instance or deployment configured to perform deployment or service operations within the network 1000, such as that discussed above.

Other example groups of IoT devices may include remote weather stations 1014, local information terminals 1016, alarm systems 1018, automated teller machines 1020, alarm panels 1022, or moving vehicles, such as emergency vehicles 1024 or other vehicles 1026, among many others. Each of these IoT devices may be in communication with other IoT devices, with servers 1004, with another IoT device or system, another edge computing or “fog” computing system, or a combination therein. The groups of IoT devices may be deployed in various residential, commercial, and industrial settings (including in both private or public environments).

As may be seen from FIG. 10, a large number of IoT devices may be communicating through the network 1000. This may allow different IoT devices to request or provide information to other devices autonomously. For example, a group of IoT devices (e.g., the traffic control group 1006) may request a current weather forecast from a group of remote weather stations 1014, which may provide the forecast without human intervention. Further, an emergency vehicle 1024 may be alerted by an automated teller machine 1020 that a burglary is in progress. As the emergency vehicle 1024 proceeds towards the automated teller machine 1020, it may access the traffic control group 1006 to request clearance to the location, for example, by lights turning red to block cross traffic at an intersection in sufficient time for the emergency vehicle 1024 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 1014 or the traffic control group 1006, may be equipped to communicate with other IoT devices as well as with the network 1000. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPv6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communicationscommunications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QoS) based swarming and coordination/combinations of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource-based trust and service indices may be inserted to improve the data integrity, quality, assurance, and deliver a metric of data confidence.

### Example Computing Devices

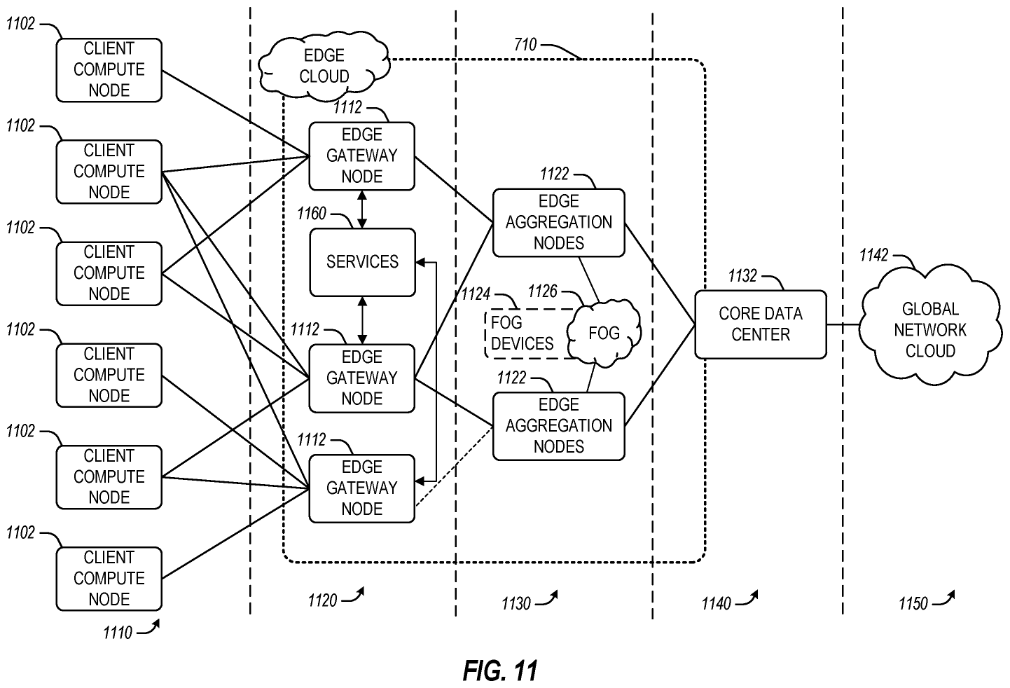

At a more generic level, an edge computing system may be described to encompass any number of deployments operating in the edge cloud 710, which provide coordination from client and distributed computing devices. FIG. 11 provides a further abstracted overview of layers of distributed compute deployed among an edge computing environment for purposes of illustration.

FIG. 11 generically depicts an edge computing system for providing edge services and applications to multi-stakeholder entities, as distributed among one or more client compute nodes 1102, one or more edge gateway nodes 1112, one or more edge aggregation nodes 1122, one or more core data centers 1132, and a global network cloud 1142, as distributed across layers of the network. The implementation of the edge computing system may be provided at or on behalf of a telecommunication service provider (“telco”, or “TSP”), internet-of-things service provider, a cloud service provider (CSP), enterprise entity, or any other number of entities. Various forms of wired or wireless connections may be configured to establish connectivity among the nodes 1102, 1112, 1122, 1132, including interconnections among such nodes (e.g., connections among edge gateway nodes 1112, and connections among edge aggregation nodes 1122). Such connectivity and federation of these nodes may be assisted with the use of container development and execution services 1160 and service instances, as discussed herein.

Each node or device of the edge computing system is located at a particular layer corresponding to layers 1110, 1120, 1130, 1140, and 1150. For example, the client compute nodes 1102 are each located at an endpoint layer 1110, while each of the edge gateway nodes 1112 is located at an edge devices layer 1120 (local level) of the edge computing system. Additionally, each of the edge aggregation nodes 1122 (and/or fog devices 1124, if arranged or operated with or among a fog networking configuration 1126) is located at a network access layer 1130 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 1132 is located at a core network layer 1140 (e.g., a regional or geographically-central level), while the global network cloud 1142 is located at a cloud data center layer 1150 (e.g., a national or global layer). The use of “core” is provided as a term for a centralized network location—deeper in the network—which is accessible by multiple edge nodes or components;

however, a “core” does not necessarily designate the “center” or the deepest location of the network. Accordingly, the core data center 1132 may be located within, at, or near the edge cloud 710.

Although an illustrative number of client compute nodes 1102, edge gateway nodes 1112, edge aggregation nodes 1122, core data centers 1132, and global network clouds 1142 are shown in FIG. 11, it should be appreciated that the edge computing system may include more or fewer devices or systems at each layer. Additionally, as shown in FIG. 11, the number of components of each layer 1110, 1120, 1130, 1140, and 1150 generally increases at each lower level (i.e., when moving closer to endpoints). As such, one edge gateway node 1112 may service multiple client compute nodes 1102, and one edge aggregation node 1122 may service multiple edge gateway nodes 1112.

Consistent with the examples provided herein, each client compute node 1102 may be embodied as any type of end point component, device, appliance, or “thing” capable of communicating as a producer or consumer of data. Further, the label “node” or “device” as used in the edge computing system 1100 does not necessarily mean that such node or device operates in a client or minion/follower/agent role; rather, any of the nodes or devices in the edge computing system 1100 refer to individual entities, nodes, or subsystems which include discrete or connected hardware or software configurations to facilitate or use the edge cloud 710.

As such, the edge cloud 710 is formed from network components and functional features operated by and within the edge gateway nodes 1112 and the edge aggregation nodes 1122 of layers 1120, 1130, respectively. The edge cloud 710 may be embodied as any type of network that provides edge computing and/or storage resources which are proximately located to radio access network (RAN) capable endpoint devices (e.g., mobile computing devices, IoT devices, smart devices, etc.), which are shown in FIG. 11 as the client compute nodes 1102. In other words, the edge cloud 710 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 710 may form a portion of or otherwise provide an ingress point into or across a fog networking configuration 1126 (e.g., a network of fog devices 1124, not shown in detail), which may be embodied as a system-level horizontal and distributed architecture that distributes resources and services to perform a specific function. For instance, a coordinated and distributed network of fog devices 1124 may perform computing, storage, control, or networking aspects in the context of an IoT system arrangement. Other networked, aggregated, and distributed functions may exist in the edge cloud 710 between the cloud data center layer 1150 and the client endpoints (e.g., client compute nodes 1102). Some of these are discussed in the following sections in the context of network functions or service virtualization, including the use of virtual edges and virtual services which are orchestrated for multiple stakeholders.

The edge gateway nodes 1112 and the edge aggregation nodes 1122 cooperate to provide various edge services and compute security features to the client compute nodes 1102. Furthermore, because each client compute node 1102 may be stationary or mobile, each edge gateway node 1112 may cooperate with other edge gateway devices to propagate presently provided edge services and compute security features as the corresponding client compute node 1102 moves about a region. To do so, each of the edge gateway nodes 1112 and/or edge aggregation nodes 1122 may support multiple tenancies and multiple stakeholder configurations, in which services from (or hosted for) multiple service providers and multiple consumers may be supported and coordinated across a single or multiple compute devices.

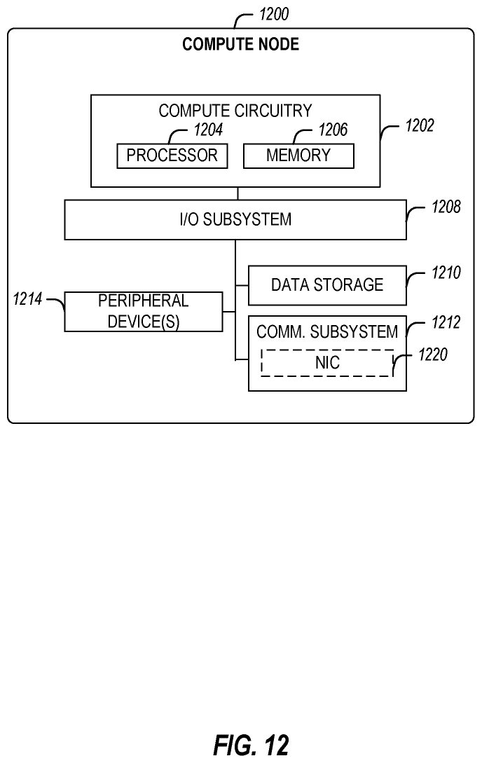

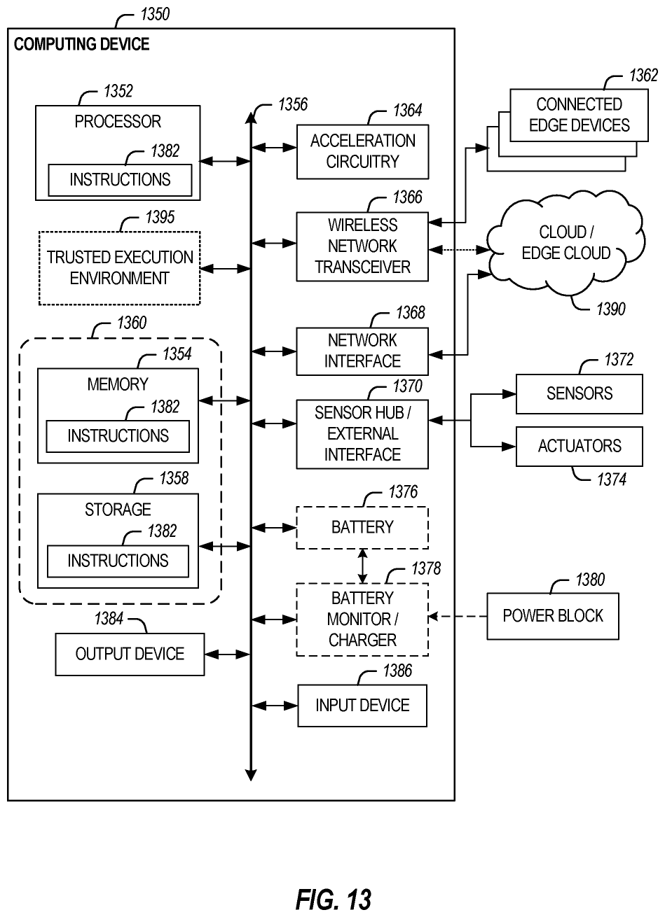

In further examples, any of the compute nodes or devices discussed with reference to the present edge computing systems and environment may be fulfilled based on the components depicted in FIGS. 12 and 13. Each edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 12, an edge compute node 1200 includes a compute engine (also referred to herein as “compute circuitry”) 1202, an input/output (I/O) subsystem 1208, data storage 1210, a communication circuitry subsystem 1212, and, optionally, one or more peripheral devices 1214. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 and a memory 1206. The processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit. In some examples, the processor 1204 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 1204 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), dedicated compute circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized compute units such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, a SOC, a CPU, and other variations of the processor 1204 may work in coordination with each other to execute many types of operations and instructions within and on behalf of the compute node 1200.

The main memory 1206 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 1206 may be integrated into the processor 1204. The main memory 1206 may store various software and data used during operation such as one or more applications, data operated on by the application(s), libraries, and drivers.

The compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the main memory 1206, and other components of the compute circuitry 1202, into the compute circuitry 1202.

The one or more illustrative data storage devices 1210 may be embodied as any type of device configured for short-term or long-term storage of data such as, for example, memory devices and circuits, memory cards, hard disk drives, solid-state drives, or other data storage devices. Each data storage device 1210 may include a system partition that stores data and firmware code for the data storage device 1210. Each data storage device 1210 may also include one or more operating system partitions that store data files and executables for operating systems depending on, for example, the type of compute node 1200.

The communication circuitry 1212 may be embodied as any communication circuit, device, or collection thereof, capable of enabling communications over a network between the compute circuitry 1202 and another compute device (e.g., an edge gateway node 1112 of the edge computing system 1100). The communication circuitry 1212 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The NIC 1220 may be embodied as one or more add-in-boards, daughter cards, network interface cards, controller chips, chipsets, or other devices that may be used by the compute node 1200 to connect with another compute device (e.g., an edge gateway node 1112). In some examples, the NIC 1220 may be embodied as part of a system-on-a-chip (SoC) that includes one or more processors or included on a multichip package that also contains one or more processors. In some examples, the NIC 1220 may include a local processor (not shown) and/or a local memory and storage (not shown) that are local to the NIC 1220. In such examples, the local processor of the NIC 1220 (which can include general-purpose accelerators or specific accelerators) may be capable of performing one or more of the functions of the compute circuitry 1202 described herein. Additionally, or alternatively, the local memory of the NIC 1220 may be integrated into one or more components of the client compute node at the board level, socket level, chip level, and/or other levels.

Additionally, in some examples, each compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node in an edge computing system (e.g., client compute node 1102, edge gateway node 1112, edge aggregation node 1122) or like forms of appliances, computers, subsystems, circuitry, or other components.

In a more detailed example, FIG. 13 illustrates a block diagram of an example of components that may be present in an edge computing device (or node) 1350 for implementing the techniques (e.g., operations, processes, methods, and methodologies) described herein. The edge computing node 1350 provides a closer view of the respective components of node 1200 when implemented as or as part of a computing device (e.g., as a mobile device, a base station, server, gateway, etc.). The edge computing node 1350 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 1350, or as components otherwise incorporated within a chassis of a larger system.

The edge computing node 1350 may include processing circuitry in the form of a processor 1352, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1352 may be a part of a system on a chip (SoC) in which the processor 1352 and other components are formed into a single integrated circuit, or a single package, such as the Edison™ or Galileo™ SoC boards from Intel Corporation, Santa Clara, Calif. As an example, the processor 1352 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or a customer thereof, or their licensees or adopters. The processors may include units such as an A5-A14processor from Apple® Inc., a Snapdragon™ processor from Qualcomm® Technologies, Inc., or an OMAP™ processor from Texas Instruments, Inc. The processor 1352 and accompanying circuitry may be provided in a single socket form factor, multiple socket form factor, or a variety of other formats, including in limited hardware configurations or configurations that include fewer than all elements shown in FIG. 13.

The processor 1352 may communicate with a system memory 1354 over an interconnect 1356 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems, and so forth, a storage 1358 may also couple to the processor 1352 via the interconnect 1356. In an example, the storage 1358 may be implemented via a solid-state disk drive (SSDD). Other devices that may be used for the storage 1358 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 1358 may be on-die memory or registers associated with the processor 1352. However, in some examples, the storage 1358 may be implemented using a micro hard disk drive (HDD) or solid-state drive (SSD). Further, any number of new technologies may be used for the storage 1358 in addition to, or instead of, the technologies described, such resistance change memories, phase change memories, holographic memories, or chemical memories, among others.

The components may communicate over the interconnect 1356. The interconnect 1356 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 1356 may be a proprietary bus, for example, used in an SoC based system. Other bus systems may be included, such as an I2C interface, an SPI interface, point to point interfaces, and a power bus, among others.

The interconnect 1356 may couple the processor 1352 to a transceiver 1366, for communications with the connected edge devices 1362. The transceiver 1366 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1362. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1366 (or multiple transceivers) may communicate using multiple standards or radios for communications at a different range. For example, the edge computing node 1350 may communicate with close devices, e.g., within about 10 meters, using a local transceiver based on BLE, or another low power radio, to save power. More distant connected edge devices 1362, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 1366 (e.g., a radio transceiver) may be included to communicate with devices or services in the edge cloud 1390 via local or wide area network protocols. The wireless network transceiver 1366 may be an LPWA transceiver that follows the IEEE 802.15.4, or IEEE 802.15.4g standards, among others. The edge computing node 1350 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1366, as described herein. For example, the transceiver 1366 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1366 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1368 may be included to provide a wired communication to nodes of the edge cloud 1390 or other devices, such as the connected edge devices 1362 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 1368 may be included to enable connecting to a second network, for example, a first NIC 1368 providing communications to the cloud over Ethernet, and a second NIC 1368 providing communications to other devices over another type of network.

Given the variety of types of applicable communications from the device to another component or network, applicable communications circuitry used by the device may include or be embodied by any one or more of components 1364, 1366, 1368, or 1370. Accordingly, in various examples, applicable means for communicating (e.g., receiving, transmitting, etc.) may be embodied by such communications circuitry.

The edge computing node 1350 may include or be coupled to acceleration circuitry 1364, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1356 may couple the processor 1352 to a sensor hub or external interface 1370 that is used to connect additional devices or subsystems. The devices may include sensors 1372, such as accelerometers, level sensors, flow sensors, optical light sensors, camera sensors, temperature sensors, a global navigation system (e.g., GPS) sensors, pressure sensors, barometric pressure sensors, and the like. The hub or interface 1370 further may be used to connect the edge computing node 1350 to actuators 1374, such as power switches, valve actuators, an audible sound generator, a visual warning device, and the like.

In some optional examples, various input/output (I/O) devices may be present within or connected to, the edge computing node 1350. For example, a display or other output device 1384 may be included to show information, such as sensor readings or actuator position. An input device 1386, such as a touch screen or keypad may be included to accept input. An output device 1384 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1350. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1376 may power the edge computing node 1350, although, in examples in which the edge computing node 1350 is mounted in a fixed location, it may have a power supply coupled to an electrical grid, or the battery may be used as a backup or for temporary capabilities. The battery 1376 may be a lithium-ion battery, or a metal-air battery, such as a zinc-air battery, an aluminum-air battery, a lithium-air battery, and the like.

A battery monitor/charger 1378 may be included in the edge computing node 1350 to track the state of charge (SoCh) of the battery 1376. The battery monitor/charger 1378 may be used to monitor other parameters of the battery 1376 to provide failure predictions, such as the state of health (SoH) and the state of function (SoF) of the battery 1376. The battery monitor/charger 1378 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, Tex.. The battery monitor/charger 1378 may communicate the information on the battery 1376 to the processor 1352 over the interconnect 1356. The battery monitor/charger 1378 may also include an analog-to-digital (ADC) converter that enables the processor 1352 to directly monitor the voltage of the battery 1376 or the current flow from the battery 1376. The battery parameters may be used to determine actions that the edge computing node 1350 may perform, such as transmission frequency, mesh network operation, sensing frequency, and the like.

A power block 1380, or other power supply coupled to a grid, may be coupled with the battery monitor/charger 1378 to charge the battery 1376. In some examples, the power block 1380 may be replaced with a wireless power receiver to obtain the power wirelessly, for example, through a loop antenna in the edge computing node 1350. A wireless battery charging circuit, such as an LTC4020 chip from Linear Technologies of Milpitas, Calif., among others, may be included in the battery monitor/charger 1378. The specific charging circuits may be selected based on the size of the battery 1376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1358 may include instructions 1382 in the form of software, firmware, or hardware commands to implement the techniques described herein. Although such instructions 1382 are shown as code blocks included in the memory 1354 and the storage 1358, it may be understood that any of the code blocks may be replaced with hardwired circuits, for example, built into an application-specific integrated circuit (ASIC).

Also in a specific example, the instructions 1382 on the processor 1352 (separately, or in combination with the instructions 1382 of the machine readable medium 1360) may configure execution or operation of a trusted execution environment (TEE) 1395. In an example, the TEE 1395 operates as a protected area accessible to the processor 1352 for secure execution of instructions and secure access to data. Various implementations of the TEE 1395, and an accompanying secure area in the processor 1352 or the memory 1354 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 1350 through the TEE 1395 and the processor 1352.

In an example, the instructions 1382 provided via memory 1354, the storage 1358, or the processor 1352 may be embodied as a non-transitory, machine-readable medium 1360 including code to direct the processor 1352 to perform electronic operations in the edge computing node 1350. The processor 1352 may access the non-transitory, machine-readable medium 1360 over the interconnect 1356. For instance, the non-transitory, machine-readable medium 1360 may be embodied by devices described for the storage 1358 or may include specific storage units such as optical disks, flash drives, or any number of other hardware devices. The non-transitory, machine-readable medium 1360 may include instructions to direct the processor 1352 to perform a specific sequence or flow of actions, for example, as described with respect to the flowchart(s) and block diagram(s) of operations and functionality depicted above. As used herein, the terms “machine-readable medium”, “computer-readable medium”, “machine-readable storage”, and “computer-readable storage” are interchangeable.

In an example embodiment, the edge computing node 1350 can be implemented using components/modules/blocks 1352-1386 which are configured as IP Blocks. Each IP Block may contain a hardware RoT (e.g., device identifier composition engine, or DICE), where a DICE key may be used to identify and attest the IP Block firmware to a peer IP Block or remotely to one or more of components/modules/blocks 1362-1380. Thus, it will be understood that the node 1350 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 12 and 13 is intended to depict a high-level view of components of a device, subsystem, or arrangement of an edge computing node. However, it will be understood that some of the components shown may be omitted, additional components may be present, and a different arrangement of the components shown may occur in other implementations.

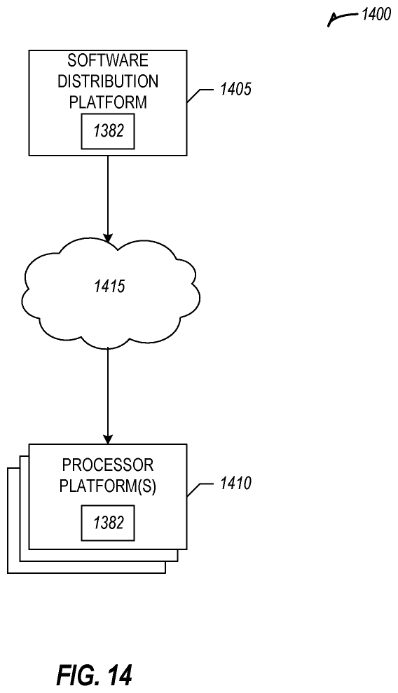

FIG. 14 illustrates an example software distribution platform 1405 to distribute software, such as the example computer readable instructions 1382 of FIG. 13, to one or more devices, such as example processor platform(s) 1410 and/or other example connected edge devices or systems discussed herein. The example software distribution platform 1405 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1405). Example connected edge devices may operate in commercial and/or home automation environments. In some examples, a third party is a developer, a seller, and/or a licensor of software such as the example computer readable instructions 1382 of FIG. 13. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 14, the software distribution platform 1405 includes one or more servers and one or more storage devices that store the computer readable instructions 1382. The one or more servers of the example software distribution platform 1405 are in communication with a network 1415, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1382 from the software distribution platform 1405. For example, the software, which may correspond to example computer readable instructions, may be downloaded to the example processor platform(s), which is/are to execute the computer readable instructions 1382. In some examples, one or more servers of the software distribution platform 1405 are communicatively connected to one or more security domains and/or security devices through which requests and transmissions of the example computer readable instructions 1382 must pass. In some examples, one or more servers of the software distribution platform 1405 periodically offer, transmit, and/or force updates to the software (e.g., the example computer readable instructions 1382 of FIG. 13) to ensure improvements, patches, updates, etc. are distributed and applied to the software at the end user devices.

In the illustrated example of FIG. 14, the computer readable instructions 1382 are stored on storage devices of the software distribution platform 1405 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1382 stored in the software distribution platform 1405 are in a first format when transmitted to the example processor platform(s) 1410. In some examples, the first format is an executable binary in which particular types of the processor platform(s) 1410 can execute. However, in some examples, the first format is uncompiled code that requires one or more preparation tasks to transform the first format to a second format to enable execution on the example processor platform(s) 1410. For instance, the receiving processor platform(s) 1400 may need to compile the computer readable instructions 1382 in the first format to generate executable code in a second format that is capable of being executed on the processor platform(s) 1310. In still other examples, the first format is interpreted code that, upon reaching the processor platform(s) 1410, is interpreted by an interpreter to facilitate execution of instructions.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A method for processing of container software package images for use in a development platform of edge computing hardware, comprising:
identifying container package data stored at a remote location, the container package data to be imported into the development platform;
storing a container image at the development platform, based on the container package data;
performing a security evaluation of the container image, before execution of the container image on the development platform;
storing results of the security evaluation of the container image in a database accessible to the development platform; and
adding the container image into a registry of containers available for execution at the development platform;
wherein execution of the container image at the development platform is based on verification of the results of the security evaluation and use of the registry of containers.

2. The method of claim 1, wherein the container package data is a pre-built container image, wherein the container image is pre-built by a remote computing system prior to import to the development platform.

3. The method of claim 1, wherein the container package data includes source code, and wherein the method further comprises:
compiling the container image from the source code or container build instructions, at the development platform, before storing the container image.

4. The method of claim 3, wherein the source code or container build instructions are obtained from a software development project repository.

5. The method of claim 1, wherein the container image is one of a plurality of container images to import into the development platform.

6. The method of claim 5, wherein the plurality of container images provides one or more containers that are inter-dependent.

7. The method of claim 1, further comprising:
implementing a configuration of the container image on the development platform.

8. The method of claim 1, wherein the development platform comprises a plurality of types of hardware available for execution of the container image.

9. The method of claim 8, further comprising:
causing the execution of the container image at the development platform, wherein the execution includes performance of one or more workloads distributed among a selected set of hardware of the plurality of types of hardware.

10. At least one non-transitory machine-readable medium capable of storing instructions for processing of container software package images, wherein the instructions when executed by a computing device of a development platform of edge computing hardware, cause the computing device to perform operations that:
obtain, from a remote location, data to import a container software package into the development platform;
store a container image at the development platform, based on the data to import the container software package;
performing a security evaluation of the container image, before execution of the container image on the development platform;
storing results of the security evaluation of the container image in a database accessible to the development platform; and
adding the container image into a registry of containers available for execution at the development platform;
wherein execution of the container image at the development platform is based on verification of the results of the security evaluation and use of the registry of containers.

11. The machine-readable medium of claim 10, wherein the data to import the container software package is a pre-built container image, wherein the container image is pre-built by a remote computing system prior to import to the development platform.

12. The machine-readable medium of claim 10, wherein the data to import the container software package includes source code, and wherein the instructions further cause the computing device to perform operations that:
compile the container image from the source code or container build instructions, at the development platform, before storing the container image.

13. The machine-readable medium of claim 12, wherein the source code or container build instructions are obtained from a software development project repository.

14. The machine-readable medium of claim 10, wherein the container image is one of a plurality of container images to import into the development platform.

15. The machine-readable medium of claim 14, wherein the plurality of container images provides one or more containers that are inter-dependent.

16. The machine-readable medium of claim 10, wherein the instructions further cause the computing device to perform operations that:
implement a configuration of the container image on the development platform.

17. The machine-readable medium of claim 10, wherein the development platform comprises a plurality of types of hardware available for execution of the container image.

18. The machine-readable medium of claim 17, wherein the instructions further cause the computing device to perform operations that:
cause the execution of the container image at the development platform, wherein the execution includes performance of one or more workloads distributed among a selected set of hardware of the plurality of types of hardware.

19. A system for managing container software package images in an edge computing development platform, the system comprising:
a storage device to store data for a plurality of container images of the development platform; and
processing circuitry to:
receive, from a remote location, data to import a container software package;
store a container image in the storage device, based on the data to import the container software package;
perform a security evaluation of the container image, before execution of the container image on the development platform;
store results of the security evaluation of the container image in the storage device; and
add the container image into a registry of containers available for execution at the development platform;
wherein execution of the container image at the development platform is based on verification of the results of the security evaluation and use of the registry of containers.

20. The system of claim 19, wherein the data to import the container software package is a pre-built container image, wherein the container image is pre-built by a remote computing system prior to import to the development platform.

21. The system of claim 19, wherein the data to import the container software package includes source code or container build instructions, wherein the source code or container build instructions are obtained from a software development project repository and wherein the processing circuitry is further to:
compile the container image from the source code or container build instructions, at the development platform, before storing the container image.

22. The system of claim 19, wherein the processing circuitry is further to:
control the execution of the container image at the development platform, wherein the execution includes performance of one or more workloads distributed among a plurality of types of hardware at the development platform.

23. An apparatus for processing of container software package images, for use in an edge computing development platform, the apparatus comprising:
means for obtaining data to import a container software package into the development platform;
means for storing a container image at the development platform, based on the data to import the container software package;
means for performing a security evaluation of the container image, before execution of the container image on the development platform;
means for storing results of the security evaluation of the container image in a database accessible to the development platform;
means for adding the container image into a registry of containers available for execution at the development platform; and
means for executing the container image at the development platform based on verification of the results of the security evaluation and use of the registry of containers.

24. The apparatus of claim 23, wherein the data to import the container software package is a pre-built container image, wherein the container image is pre-built by a remote computing system prior to import to the development platform.

25. The apparatus of claim 23, wherein the data to import the container software package includes source code or container build instructions, wherein the source code or container build instructions are obtained from a software development project repository, and wherein the apparatus further comprises:
means for compiling the container image from the source code or container build instructions before storing the container image.
